(19) United States
(12) Patent Application Publication
(10) Pub. No.: US 2011/0212318 A1
(43) Pub. Date: Sep. 1, 2011

(54) NANOSCALE IR ABSORBERS IN MULTILAYER MOLDINGS

(75) Inventors: Johannes Loebel, Mannheim (DE); Guenter Scherer, Neustadt (DE); Sami Schehata, Neuhofen (DE)

(73) Assignee: BASF SE, Ludwigshafen (DE)

(21) Appl. No.: 13/125,414

(22) PCT Filed: Oct. 19, 2009
(86) PCT No.: PCT/EP2009/063636

§ 371 Date: Apr. 21, 2011

(30) Foreign Application Priority Data
Oct. 28, 2008 (EP) 08167760.1

(51) Int. Cl. B32B 3/26; B32B 27/06; B32B 27/34; B32B 27/36; B32B 27/00; B28B 5/00

(52) U.S. Cl. 428/304.4; 428/500; 428/412; 428/473.5; 428/474.4; 428/480; 428/411.1; 264/250

(57) ABSTRACT

Multilayer moldings (1) comprising an outer layer (2) comprising a thermoplastic polymer and at least one nanoscale IR absorber (8), and also an inner layer (3) arranged under the outer layer (2) and comprising a thermoplastic polymer. Multilayer molding (1) where the following are used as additional additives: UV absorbers, non-particulate organic IR absorbers, stabilizers, antioxidants, colorants, inorganic salts, pearl-luster pigments, NIR-reflective substances, antifogging agents, or fillers. Multilayer moldings (1) taking the form of a panel or sheeting. Process for the production of a multilayer molding (1) via coextrusion of the outer layer (2) and of the inner layer (3). Use of multilayer moldings in heat management, in agriculture, as window constituent, or as constituent of panels having cavities, twin-web panels, multi-web sandwich panels, or solid panels.

The present invention relates to multilayer moldings which comprise nanoscale IR absorbers. The present invention further relates to processes for the production of multilayer moldings of this type. The invention likewise relates to uses of these multilayer moldings, in particular in heat management, as greenhouse sheetings, or as constituent of windows. The invention further relates to articles comprising multilayer moldings of this type.

Further embodiments of the present invention can be found in the claims, in the description, and in the examples. The abovementioned features of the subject matter of the invention, and the features which will be explained below, can, of course, be used not only in each specific stated combination but also in other combinations, without exceeding the scope of the invention. The preferred or very preferred embodiments of the present invention are those in which the definitions of the features are the preferred and, respectively, very preferred definitions.

US 2008/0075936 A1 describes films for the control of insolation, and also methods for the production of films of this type. These films comprise a single- or multilayer core region which comprises at least one layer composed of an oriented thermoplastic material. There are IR-absorbent nanoparticles dispersed in the oriented thermoplastic.

EP 1 865 027 A1 describes certain selected polycarbonate resins which comprise fine-particle metal borides. The products produced from these resin compositions exhibit optical transparency and shielding from thermal radiation. The products mentioned in EP 1 865 027 A1 can be used as window materials, roofing materials, or as agricultural sheetings.

US 2004/0028920 A1 describes a masterbatch comprising a component for shielding from thermal radiation, and a thermoplastic polymer. For shielding from thermal radiation, an amount of from 0.01 to 20% by weight, based on the thermoplastic polymer, of hexaborides is used. According to the information in US 2004/0028920 A1, a masterbatch of this type can be used to produce moldings with high transparency to visible light, and also with a high level of shielding from thermal radiation.

EP 1 529 632 A1 describes multilayer sheetings and processes for their production. The multilayer sheetings comprise a core region with a layer composed of a thermoplastic polymer and an IR absorber. This core layer is surrounded by an upper layer composed of a thermoplastic polymer comprising further additives, or by an upper and lower layer composed of a thermoplastic polymer comprising further additives. The technical teaching of EP 1 529 632 A1 emphasizes the necessity of dispersing the IR absorber in the core layer of the multilayer sheeting, since according to the information in EP 1 529 632 A1a marked rise in clouding of the material is observed with dispersion of the IR absorber in the upper layer; cf. paragraphs [0075] to [0082] of EP 1 529 632 A1.

Excessive absorption of thermal radiation, particularly of the thermal radiation in sunlight, by the surface of, for example, buildings, vehicles, warehouses, or greenhouses often leads to a marked rise in internal temperatures, particularly in regions with high insolation. This increased heating, e.g. of the interior of buildings or people present within the buildings, is often compensated by using engineering methods involving the energy-intensive use of air-conditioning systems. By way of example, temperatures above 60° C. are regularly achieved in the interior of a vehicle parked in the sun during summer.

However, the intention is often that the shielding from thermal radiation should not likewise involve shielding from other regions of the solar spectrum. Particularly in the case of shielding from thermal radiation through windows or greenhouse sheetings, high transparency in the visible spectral region is desired, alongside effective shielding from thermal radiation. In these applications specifically, therefore, the thermal protection is not permitted to cause more than slight clouding of the materials.

It was therefore an object of the present invention to provide shielding from thermal radiation when light, in particular insolation, acts on the surface of, for example, buildings, vehicles, or greenhouses.

A further partial object of the invention was to provide high transparency to visible light together with effective shielding from thermal radiation.

These and other objects were achieved as described below via multilayer moldings (1) comprising:
a. an outer layer (2) comprising
   i. a thermoplastic polymer and
   ii. at least one nanoscale IR absorber (8), and also
b. an inner layer (3) arranged under the outer layer (2) and comprising
   i. a thermoplastic polymer.

It is, of course, possible that the outer layer (2) or the inner layer (3) also comprises mixtures of thermoplastic polymers. “At least one” nanoscale IR absorber means that the material can comprise “one or more” nanoscale IR absorbers.

For the purposes of the present invention, infrared radiation (abbreviated to IR radiation) is electromagnetic waves in the spectral region between visible light and the longer-wavelength microwaves. This corresponds to a wavelength range from about 760 nm to 1 mm. For short-wave IR radiation (starting at 760 nm), the term near infrared (NIR) is often used, and for wavelengths of from about 5-25 micrometers the term middle infrared (MIR) is often used. Extremely long-wave IR radiation (from 25 μm to 1 mm) is termed far infrared (FIR). Thermal radiation is particularly infrared radiation.

For the purposes of the present invention, UV radiation is electromagnetic waves in the spectral range from about 200 nm to 400 nm.

For the purposes of the present invention, visible light is electromagnetic waves in the spectral range from about 400 nm to 760 nm.

A material is generally called transparent if objects located behind it can be discerned relatively clearly—an example being window glass. For the purposes of the present invention, transparency means optical transparency in essence without scattering of light by the transparent material, in the visible spectral region.

For measurement of haze, a haze tester can be used, for example from Byk-Gardner. It is composed of a tube which is placed in front of an Ulbricht sphere. Haze can be measured to ASTM D1003-7, as mentioned by way of example in EP 1 529 632 A1.

For the purposes of the present invention, substances which absorb electromagnetic radiation in the wavelength range of IR radiation are also termed IR absorbers. IR absorbers preferably have absorption in the wavelength range from 760 to 2000 nm, very preferably from 780 to 1500 nm, and an extinction coefficient for IR radiation of at least 100 l/(cm*mol). The extinction coefficient for IR radiation is preferably above 1000 l/(cm*mol) and very preferably above 10⁴ I/(cm*mol).

For the purposes of the present invention, “nanoscale” or “nanoparticulate” are terms used for particles whose greatest average diameter is smaller than 500 nanometers (nm), preferably from 10 to 300 nm, in particular from 20 to 200 nm. The nanoscale particles can be either inorganic or organic, or else comprise a mixture of organic/inorganic constituents. The particle size or the particle size distribution of nanoparticulate particles can, as is known to the person skilled in the art, be determined by way of example via dynamic light scattering or via electron microscopy, e.g. transmission electron micrographs.

The location of the outer layer (2) of the multilayer molding (1) is on that side or surface of the multilayer molding that faces toward the light, particularly the sunlight, or the thermal radiation (9), whereas the location of the inner layer (3) is on that side facing away from the light or from the thermal radiation.

The location of the outer layer (2) of the multilayer molding (1) is in the direct vicinity of the inner layer (3). “In the direct vicinity” means that the only separation between the inner layer (3) and the outer layer (2) is provided by one or more further layers or cavities with a total thickness of at most 50 mm for the further layers. In one preferred embodiment of the multilayer molding (1) of the invention, the outer layer (2) is in direct contact with the inner layer (3).

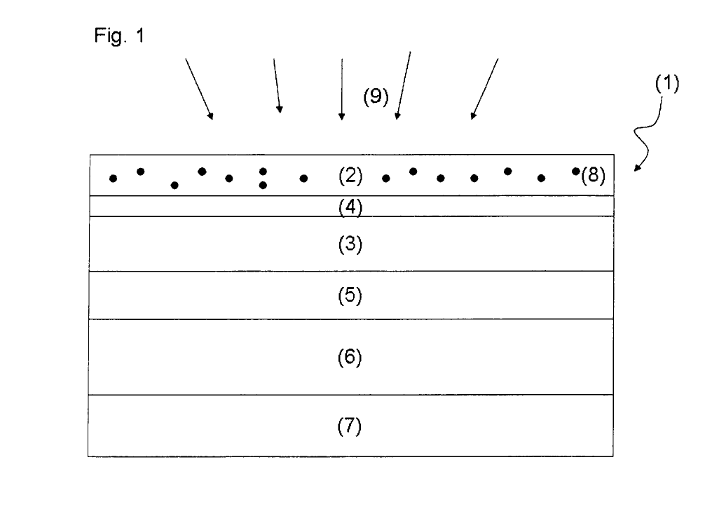

The location of optional further layers of the multilayer molding (1) of the invention, for example (5), (6) and/or (7), is generally, as can be seen in FIG. 1, below the inner layer (3) on that side of the multilayer molding facing away from the light. However, it is also, to a small extent, possible that there are further layers (4) between outer layer (2) and inner layer (3), but the location of the outer layer (2) is always in the direct vicinity of the inner layer (3). The further layers can also have cavities, in particular air-filled cavities.

In one preferred embodiment of the multilayer molding (1), this is composed of two layers, namely the outer layer (2) and the inner layer (3).

In another embodiment of the multilayer molding (1), this is composed of three layers, namely the outer layer (2), the inner layer (3), and a further layer (5) below the inner layer (3), which preferably has a constitution the same as that of the outer layer (2).

The layer thickness of the outer layer (2), of the inner layer (3), and of the optional further layers can by way of example vary within a wide range as a function of application. The layer thickness is often from 0.01 to 50 mm, preferably from 0.75 to 30 mm, very preferably from 0.85 to 25 mm, and particularly from 1 mm to 20 mm.

In one preferred embodiment of the multilayer molding (1), the layer thickness of the outer layer (2) is from 0.01 to 1 mm, preferably from 0.02 to 0.5 mm, particularly preferably from 0.03 to 0.1 mm, and particularly from 0.03 to 0.05 mm.

Thermoplastic polymers that can be used are oligomers, polymers, ionomers, dendrimers, copolymers, such as block copolymers, graft copolymers, star-shaped block copolymers, random block copolymer, or a mixture of these.

The weight-average molar masses Mw of the thermoplastic polymers are generally from 3000 to 1 000 000 g/mol. Mw is preferably from 10 000 to 100 000 g/mol, very preferably from 20 000 to 50 000 g/mol, particularly from 25 000 to 35 000 g/mol.

The thermoplastic polymers used in the outer layer (2) generally comprise polymers with high optical transparency, but it is also possible to use opaque polymers. Preference is given to polymers with high transparency in the visible spectral region. The person skilled in the art generally selects, for the thermoplastic polymers in the outer layer (2), polymers with good weathering resistance, with low water absorption, with high chemicals resistance, and with high mechanical strength, for example scratch resistance. It is preferable that the thermoplastic polymers of the outer layer (2) have good compatibility in the melt with the thermoplastic polymers of the inner layer (3).

In one preferred embodiment of the multilayer molding (1) of the invention, the thermoplastic polymer in the outer layer (2) is a polyacetal, polyacrylate, polyalkyl acrylate, polycarbonate, polystyrene, polyester, polyamide, polyamideimide, polyarylate, polyaryl sulfone, polyether sulfone, polyphenyl sulfide, polyvinyl chloride, polysulfone, polyimide, polyetherimide, polytetrafluoroethylene, polyetherketone, polyetheretherketone, polyetherketoketone, polybenzoxazole, polyoxadiazole, polybenzothiazinophenothiazine, polybenzothiazole, polypyrazinoquinoxaline, polypyromellitimide, polyquinoxaline, polybenzimidazole, polyoxindole, polyoxoisoindoline, polydisoxoisoindoline, polytriazine, polypyridazine, polypiperazine, polypyridine, polypiperidine, polytriazole, polypyrazole, polypyrrolidine, polycarborane, polyoxabicyclononane, polybicyclonone, polydibenzofuran, polyphthalide, polyacetal, polyanhydride, polyvinyl ether, polyvinyl thioether, polyvinyl alcohol, polyvinyl ketone, polyvinyl halide, polyvinyl nitrile, polyvinyl ester, polysulfonate, polysulfide, polythioester, polysulfonamide, polyurethane, polyphosphazine, polysilazane, polyimide, polymethyl methacrylate (PMMA), polyethylene terephthalate (PET), polyolefins, such as polyethylene (PE) or polypropylene (PP), acrylonitrile-styrene-acrylate (ASA), polyvinyl butyral, or a mixture composed of these polymers. Mixtures also comprise blends of these polymers.

It is preferable that the thermoplastic polymers used in the outer layer (2) comprise polycarbonates, polyesters, or blends composed of polyester and polycarbonate, or comprise polycarbonate-polyester copolymers, polycarbonate-polysiloxane copolymers, PMMA, PE, or PET. Particular preference is given to polycarbonates, PE, or PMMA.

The thermoplastic polymers used in the inner layer (3) generally comprise polymers with high optical transparency, but it is also possible to use opaque polymers. Preference is given to polymers with high transparency in the visible spectral region. The person skilled in the art generally selects, for the thermoplastic polymers in the inner layer (3), polymers with good weathering resistance, with low water absorption, with high chemicals resistance, and with high mechanical strength. It is preferable that the thermoplastic polymers of the inner layer (3) have good compatibility in the melt with the thermoplastic polymers of the outer layer (2).

In one preferred embodiment of the multilayer molding (1) of the invention, the thermoplastic polymer in the inner layer (3) is a polyacetal, polyacrylate, polyalkyl acrylate, polycarbonate, polystyrene, polyester, polyamide, polyamideimide, polyarylate, polyaryl sulfone, polyether sulfone, polyphenyl sulfide, polyvinyl chloride, polysulfone, polyimide, polyetherimide, polytetrafluoroethylene, polyetherketone, polyetheretherketone, polyetherketoketone, polybenzoxazole, polyoxadiazole, polybenzothiazinophenothiazine, polybenzothiazole, polypyrazinoquinoxaline, polypyromellitimide, polyquinoxaline, polybenzimidazole, polyoxindole, polyoxoisoindoline, polydisoxoisoindoline, polytriazine, polypyridazine, polypiperazine, polypyridine, polypiperidine, polytriazole, polypyrazole, polypyrrolidine, polycarborane, polyoxabicyclononane, polybicyclonone, polydibenzofuran, polyphthalide, polyacetal, polyanhydride, polyvinyl ether, polyvinyl thioether, polyvinyl alcohol, polyvinyl ketone, polyvinyl halide, polyvinyl nitrile, polyvinyl ester, polysulfonate, polysulfide, polythioester, polysulfonamide, polyurethane, polyphosphazine, polysilazane, polyimide, polymethyl methacrylate (PMMA), polyethylene terephthalate (PET), polyolefins, such as polyethylene (PE) or polypropylene (PP), acrylonitrile-styrene-acrylate (ASA), polyvinyl butyral, or a mixture composed of these polymers. Mixtures also comprise blends of these polymers.

It is preferable that the thermoplastic polymers used in the inner layer (3) comprise polycarbonates, polyesters, or blends composed of polyester and polycarbonate, or comprise polycarbonate-polyester copolymers, polycarbonate-polysiloxane copolymers, PMMA, PE, or PET. Particular preference is given to polycarbonates, PE, or PMMA.

In another embodiment of the multilayer molding (1) of the invention, a scratch-resistant, particularly transparent, coating can be applied on the outer layer (2), on that side facing away from the inner layer (3).

The optional further layers of the multilayer molding of the invention likewise generally comprise one of the abovementioned thermoplastic polymers. It is preferable that the polymers used in the optional further layer are selected from the abovementioned preferred thermoplastic polymers of the outer layer or of the inner layer. It is very preferable that the polymers used in the optional further layer correspond to the thermoplastic polymers of the outer layer or of the inner layer.

In another preferred embodiment of the multilayer molding (1) of the invention, the thermoplastic polymers in the outer layer (2) and in the inner layer (3) are the same, and are a polyacetal, polyacrylate, polyalkyl acrylate, polycarbonate (PC), polystyrene, polyester, polyamide, polyamideimide, polyarylate, polyaryl sulfone, polyether sulfone, polyphenyl sulfide, polyvinyl chloride, polysulfone, polyimide, polyetherimide, polytetrafluoroethylene, polyetherketone, polyetheretherketone, polyetherketoketone, polybenzoxazole, polyoxadiazole, polybenzothiazinophenothiazine, polybenzothiazole, polypyrazinoquinoxaline, polypyromellitimide, polyquinoxaline, polybenzimidazole, polyoxindole, polyoxoisoindoline, polydisoxoisoindoline, polytriazine, polypyridazine, polypiperazine, polypyridine, polypiperidine, polytriazole, polypyrazole, polypyrrolidine, polycarborane, polyoxabicyclononane, polybicyclonone, polydibenzofuran, polyphthalide, polyacetal, polyanhydride, polyvinyl ether, polyvinyl thioether, polyvinyl alcohol, polyvinyl ketone, polyvinyl halide, polyvinyl nitrile, polyvinyl ester, polysulfonate, polysulfide, polythioester, polysulfone, polysulfonamide, polyurethane, polyphosphazine, polysilazane, polyimide, polymethyl methacrylate, polyethylene terephthalate (PET), polyolefins, acrylonitrile-styrene-acrylate (ASA), polyamide, polyether sulfone, polyvinyl chloride, polysulfone, or a mixture composed of these polymers. Mixtures also comprise blends of these polymers.

It is preferable that in the case of identical thermoplastic polymers in the outer layer (2) and in the inner layer (3) the polymers used comprise PC, PE, or PMMA. PC and PE are particularly preferred.

In one preferred embodiment of the multilayer molding (1) of the invention, the nanoscale IR absorbers (8) are used in finely dispersed form. The term “finely dispersed” means that there is uniform dispersion of the IR absorbers (8) in the outer layer (2). This type of dispersion is achieved in so far as the nanoscale IR absorbers in essence form no aggregates or particles larger than 500 nm. It is preferable that no aggregates or particles larger than 300 nm are present, and it is very preferable that no aggregates or particles larger than 200 nm are present. In particular, separate nanoparticles are present with an average separation of at least 200 nm. In one embodiment, more than 90% of the particles have an average particle size of less than 200 nm. In another embodiment, more than 95% of the particles have an average particle size of less than 200 nm. In another embodiment, more than 99% of the particles have an average particle size of less than 200 nm.

In another preferred embodiment of the multilayer molding (1) of the invention, the outer layer (2) comprises no particles or aggregates with an average particle size of more than 500 nm. It is preferable that the material comprises no particles or aggregates with a diameter of more than 300 nm.

It is preferable that nanoscale IR absorbers in particulate form are used. These particles can assume any desired shape. By way of example, spherical, prismatic, or lamellar particles, or particles with irregular shape, may be used. It is also possible to use nanoscale IR absorbers with bimodal or multimodal particle size distributions.

The IR absorbers used preferably comprise nanoscale tin oxide, doped with antimony (ATO) or indium (ITO), or comprise a nanoscale metal boride (MBₓ, where x is from 1 to 6), particularly of the rare earths. Particular preference is given to nanoparticulate borides of the rare earths. Very particular preference is given to metal hexaborides of the symbolic formula MB₆, particularly where M=La, Pr, Nd, Ce, Tb, Dy, Ho, Y, Sm, Eu, Er, Tm, Yb, Lu, Sr, Ca. Preference is likewise given to metal diborides MB₂, particularly where M=Ti, Zr, Hf, V, Ta, Cr, Mo. Other suitable metal borides are Mo₂B₅, MoB, W₂B₅. Nanoscale lanthanum hexaboride (LaB₆) is a very excellent IR absorber. Mixtures of the nanoscale substances mentioned are, of course, also suitable as IR absorbers. Nanoparticulate LaB₆ is commercially available, or can be produced according to the processes in WO 2006/134141 or WO2007/107407.

The amount of IR absorber used can vary within a wide range and depends by way of example on the surface exposed to the thermal radiation on the outer layer (2). The amount used of IR absorber is also generally dependent on the layer thickness of the outer layer (2) used. A decisive factor for effective action of the IR absorber is generally that when the thermal radiation passes through the outer layer (2) there is sufficient IR absorber present in the radiation path to absorb the thermal radiation.

The amount of nanoscale IR absorber is up to 2% by weight, based on the thermoplastic polymer of the outer layer (2). The amount of IR absorber is preferably from 0.001 to 1% by weight, very preferably from 0.01 to 0.8% by weight, and particularly from 0.01 to 0.5% by weight.

The proportion of the IR radiation impacting the surface of the multilayer molding (1) of the invention and absorbed thereby depends on the respective desired application. By way of example, the multilayer molding absorbs more than 5% of the IR radiation incident on its surface. The amount absorbed of the IR radiation impacting the surface is preferably more than 20%, very preferably more than 50%, and particularly more than 90%.

In another preferred embodiment of the multilayer molding (1) of the invention, the outer layer (2) comprises only a small content of ZrO₂. The material preferably comprises less than 0.2% by weight, based on the outer layer (2), particularly preferably 0.15% by weight, of ZrO₂.

In another preferred embodiment of the multilayer molding (1) of the invention, the outer layer (2) preferably comprises from 0.001 to 1% by weight, very preferably from 0.01 to 0.8% by weight, and particularly from 0.01 to 0.5% by weight, of LaB₆ and only a small content of ZrO₂. The amount of ZrO₂ is preferably less than 50% by weight, based on the total amount of ZrO₂ and LaB₆, particularly preferably less than 40% by weight.

In another embodiment of the multilayer molding (1) of the invention, additional additives are used in the outer layer (2) and/or in the inner layer (3). It is preferable that the following are used as additional additives: UV absorbers, nonparticulate organic IR absorbers, stabilizers, antioxidants, colorants, inorganic salts, pearl-luster pigments, NIR-reflective substances, antifogging agents, or fillers. Nonparticulate organic IR absorbers are not present in the form of nanoscale particles but in the form of molecular solution in the matrix of the thermoplastic polymer.

In one preferred embodiment of the multilayer molding (1) of the invention, stabilizers are also used in the outer layer (2), in order to compensate for the effects on the thermoplastic polymer of the temperature increase, typically from 10 to 30° C., caused by the absorption of the thermal radiation. A further advantage of this embodiment is that the thermoplastic polymer of the outer layer (2) is stabilized during processing, for example in the melt. This advantage can, of course, also be utilized for the processing of the thermoplastic polymer of the inner layer (3). Overall, therefore, the additional use of a stabilizer contributes to the lengthening of the lifetime of the multilayer molding.

Examples of stabilizers that may be mentioned here are phosphites, phosphonites, phosphines, hindered amines (HALS compounds), hydroxylamines, phenols, acryloyl-modified phenols, peroxide scavengers, benzofuranone derivatives, and mixtures of these. Many stabilizers are commercially available, for example with the following trademarks: IRGAPHOS® 168, DOVERPHOS® S-9228, ULTRANOX® 641 from Ciba and Dover. In addition to the stabilizers, it is also possible to use costabilizers, in order to increase thermal stability.

Preferred stabilizers are phosphites or HALS compounds. Very particular preference is given to HALS compounds from Ciba, available with trademark Chimasorb®, particularly Chimasorb® 119 FL, 2020, 940, or Tinuvin®, particularly Tinuvin® 111, 123, 492, 494, 622, 765, 770, 783, 791, C 353. Other very preferred compounds are HALS compounds from BASF SE, which are available with trademark Uvinul®, particularly Uvinul® 4050 H(CAS No. 124172-53-8), Uvinul® 4077 H(CAS No. 52829-07-09), or Uvinul® 5050 H(CAS No. 152261-33-1).

The amount generally used of the stabilizers is from 0.001 to 3% by weight, based on the outer layer (2) and, respectively, inner layer (3), preferably from 0.002 to 2% by weight, very preferably from 0.003 to 1% by weight, and particularly from 0.005 to 0.5% by weight. If a costabilizer is used, the amount used of this is from 0.001 to 2% by weight, based on the outer layer (2) and, respectively, inner layer (3).

In one particularly preferred embodiment of the multilayer molding (1), a UV absorber is also used in the outer layer (2), providing still further lengthening of the lifetime of the multilayer molding.

UV absorbers absorb UV light with wavelength less than 400 nm, particularly from 200 to 400 nm. UV absorbers can therefore by way of example absorb UV-A (from 320 to 400 nm), UV-B (from 290 to 319 nm), and/or UV-C (from 200 to 289 nm). It is preferable that UV absorbers absorb UV-A and/or UV-B. It is very particularly preferable that UV absorbers absorb UV-A and/or UV-B and deactivate the energy absorbed from the light without generating any radiation.

Examples of UV absorbers that can be used are the commercially available compounds of the Tinuvin® family of products, particularly Tinuvin® 234, 326, 327, 328, or Uvinul® family of products from Ciba or BASF SE.

The Uvinul® light stabilizers comprise compounds from the following classes: benzophenones, benzotriazoles, cyanoacrylates, cinnamic esters, para-aminobenzoates, naphthalimides. Other known chromophores are also used, examples being hydroxyphenyltriazines or oxalanilides. Compounds of this type are used by way of example alone or in mixtures with other light stabilizers in cosmetic applications, for example sunscreens, or for the stabilization of organic polymers. One UV absorber used with particular preference is 4-n-octyloxy-2-hydroxybenzophenone. Other examples of UV absorbers are:

substituted acrylates, e.g. ethyl or isooctyl α-cyano-β,β-diphenylacrylate (mainly 2-ethylhexyl α-cyano-β,β-diphenylacrylate), methyl α-methoxycarbonyl-β-phenylacrylate, methyl α-methoxycarbonyl-β-(p-methoxyphenyl)acrylate, methyl or butyl α-cyano-β-methyl-β-(p-methoxyphenyl)acrylate, N-(β-methoxycarbonyl-β-cyanovinyl)-2-methylindoline, octyl p-methoxycinnamate, isopentyl 4-methoxycinnamate, urocanic acid, or salts or esters thereof.

derivatives of p-aminobenzoic acid, particularly its esters, e.g. ethyl 4-aminobenzoate or ethoxylated ethyl 4-aminobenzoate, salicylates, substituted cinnamates, such as octyl p-methoxycinnamate or 4-isopentyl 4-methoxycinnamate, or 2-phenylbenzimidazole-5-sulfonic acid, or salts thereof.
2-Hydroxybenzophenone derivatives, e.g. 4-hydroxy-, 4-methoxy-, 4-octyloxy-, 4-decyloxy-, 4-dodecyloxy-, 4-benzyloxy-, 4,2′,4′-trihydroxy-, or 2′-hydroxy-4,4′-dimethoxy-2-hydroxybenzophenone, or else the sodium salt of 4-methoxy-2-hydroxybenzophenonesulfonic acid;
esters of 4,4-diphenylbutadiene-1,1-dicarboxylic acid, e.g. the bis(2-ethylhexyl) ester;
2-phenylbenzimidazole-4-sulfonic acid, and also 2-phenylbenzimidazole-5-sulfonic acid, or salts thereof;
derivatives of benzoxazoles;
derivatives of benzotriazoles or of 2-(2′-hydroxyphenyl)benzotriazoles, e.g. 2-(2H-benzotriazol-2-yl)-4-methyl-6-(2-methyl-3-((1,1,3,3-tetramethyl-1-(trimethylsilyloxy)disiloxanyl)propyl)phenol, 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-[2′-hydroxy-5′-(1,1,3,3-tetramethylbutyl)phenyl]benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-[3′,5′-bis(α,α-dimethylbenzyl)-2′-hydroxyphenyl]benzotriazole, 2-[3′-tert-butyl-2′-hydroxy-5′-(2-octyloxycarbonylethyl)phenyl]-5-chlorobenzotriazole, 2-[3′-tert-butyl-5′-(2-(2-ethylhexyloxy)carbonylethyl)-2′-hydroxyphenyl]-5-chlorobenzotriazole, 2[3′-tert-butyl-2′-hydroxy-5′-(2-methoxycarbonylethyl)phenyl]-5-chlorobenzotriazole, 2-[3′-tert-butyl-2′-hydroxy-5′-(2-methoxycarbonylethyl)phenyl]benzotriazole, 2-[3′-tert-butyl-2′-hydroxy-5′-(2-octyloxycarbonylethyl)phenyl]benzotriazole, 2-[3′-tert-butyl-5′-(2-(2-ethylhexyloxy)carbonylethyl)-2′-hydroxyphenyl]benzotriazole, 2-(3′-dodecyl-2′-hydroxy-5′-methylphenyl)benzotriazole, 2-[3′-tert-butyl-2′-hydroxy-5′-(2-isooctyloxycarbonylethyl)phenyl]benzotriazole, 2,2′-methylenebis[4-(1,1,3,3-tetramethylbutyl)-6-benzotriazol-2-ylphenol], the fully esterified product of 2-[3′-tert-butyl-5′-(2-methoxycarbonylethyl)-2′-hydroxyphenyl]-2H-benzotriazole with polyethylene glycol 300, [R—CH2CH2—COO(CH2)3-]2, where R is 3′-tert-butyl-4-hydroxy-5′-2H-benzotriazol-2-ylphenyl, 2-[2′-hydroxy-3′-(α,α-dimethylbenzyl)-5′-(1,1,3,3-tetramethylbutyl)phenyl]benzotriazole, 2-[2′-hydroxy-3′-(1,1,3,3-tetramethylbutyl)-5′-(α,α-dimethylbenzyl)phenyl]benzotriazole;
benzylidenecamphor or its derivatives, for example those mentioned in DE-A 38 36 630, e.g. 3-benzylidenecamphor, 3(4′-methylbenzylidene)d-1-camphor;
α-(2-oxoborn-3-ylidene)toluene-4-sulfonic acid or its salts, N,N,N-trimethyl-4-(2-oxoborn-3-ylidenemethyl)anilinium monosulfate;
dibenzoylmethanes, e.g. 4-tert-butyl-4′-methoxydibenzoylmethane;
2,4,6-triaryltriazine compounds, such as 2,4,6-tris{N-[4-(2-ethylhex-1-yl)oxycarbonylphenyl]amino}-1,3,5-triazine, 4,4′-((6-(((tert-butyl)aminocarbonyl)phenylamino)-1,3,5-triazine-2,4-diyl)imino)bis(2′-ethylhexyl benzoate);
2-(2-hydroxyphenyl)-1,3,5-triazines, e.g. 2,4,6-tris(2-hydroxy-4-octyloxyphenyl)1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-[2-hydroxy-4-(2-hydroxy-3-butyloxypropyloxy)phenyl]-4,6-bis(2,4-dimethylphenyl)-1,3,5-triazine, 2-[2-hydroxy-4-(2-hydroxy-3-octyloxypropyloxy)phenyl]-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

Other suitable UV absorbers can be found in the publication Cosmetic Legislation, vol. 1, Cosmetic Products, European Commission 1999, pp. 64-66, which is hereby incorporated herein by way of reference.

Suitable UV absorbers are also described in lines 14 to 30 ([0030]) on page 6 of EP 1 191 041A2. The entire contents of that publication are incorporated herein by way of reference.

The amount generally used of the UV absorbers is from 5% by weight to 15% by weight, based on the thermoplastic polymer of the outer layer (2) or of the inner layer (3). It is preferable to use from 7 to 14% by weight of UV absorber and very preferable to use from 8 to 12% by weight, particularly from 9 to 11% by weight.

The proportion of the UV radiation impacting the surface of the multilayer molding of the invention and absorbed thereby depends on the respective desired application. By way of example, the multilayer molding of the invention absorbs more than 5% of the UV radiation incident on its surface. The amount absorbed of the UV radiation impacting the surface is preferably more than 20%, very preferably more than 50%, and particularly more than 90%.

For the use of the multilayer molding of the invention, it is generally advantageous that a maximum proportion of the IR and UV radiation is absorbed, but at the same time maximum transparency of the multilayer molding is preferred in the visible range of the spectrum. The transparency in the visible range of the spectrum is generally more than 20%. The transparency in the visible range of the spectrum is preferably more than 30%, very preferably more than 40%, particularly more than 50%.

It is moreover advantageous that the haze of the multilayer moldings of the invention is generally low. The haze is generally below 5%, preferably below 2%, very preferably below 1.8%, and particularly below 1.6%.

In another embodiment of the multilayer molding (1), nonparticulate organic IR absorbers are also used in the outer layer (2), and these supplement and improve the absorption of the nanoscale IR absorbers.

In another embodiment of the multilayer molding (1), antioxidants are also used in the outer layer (2).

In another embodiment of the multilayer molding (1), UV absorbers and nonparticulate organic IR absorbers are also used in the outer layer (2).

In another embodiment of the multilayer molding (1), UV absorbers and antioxidants are also used in the outer layer (2).

In another embodiment of the multilayer molding (1), antioxidants and nonparticulate organic IR absorbers are also used in the outer layer (2).

In another embodiment of the multilayer molding (1), UV absorbers, antioxidants, and nonparticulate organic IR absorbers are also used in the outer layer (2).

The person skilled in the art can moreover use the known polymer additives, examples being colorants, e.g. dyes and/or pigments, lubricants, impact modifiers, wetting agents, antioxidants, biocides, flame retardants, fillers, e.g. silica, Aerogels, or carbon black, glass beads, fibers, e.g. carbon fibers and/or glass fibers, antistatic agents, inorganic salts, e.g. sulfates or oxides, such as titanium dioxide or barium sulfate, pearl-luster pigments, or NIR-reflective substances, either in the outer layer (2), or in the inner layer (3), or else in the optional further layers.

In another embodiment, the further layers of the multilayer molding (1) of the invention can likewise comprise the abovementioned additives, such as UV absorbers, stabilizers, antioxidants, etc., the amount of these being as described for the outer layer (2) or the inner layer (3).

In another embodiment, the further layers of the multilayer molding (1) of the invention can likewise comprise IR absorbers, their amount being as described for the outer layer (2).

The shape of the multilayer moldings of the invention can be very different as a function of the desired application. The total layer thickness of the multilayer molding, being the total of the layer thicknesses of outer layer, inner layer, and optional further layers, is generally less than the length or width of the molding. It is preferable that the length and/or the width of the molding are greater by at least a factor of 10 than the total layer thickness, particularly preferably by at least a factor of 20, particularly by a factor of at least 100.

The moldings of the invention preferably take the form of panels, for example panels having cavities, twin-web panels or multi-web sandwich panels, or solid panels, or take the form of sheeting.

The invention also provides a process for the production of a multilayer molding (1), where an outer layer (2) comprising a thermoplastic polymer, and comprising at least one nanoscale IR absorber, and optionally comprising at least one UV absorber, and optionally comprising at least one organic IR absorber, and optionally comprising antioxidants, is applied to the surface of an inner layer (3) comprising a thermoplastic polymer.

Outer layer (2) and inner layer (3) here are produced in advance either simultaneously or in succession via processes known to the person skilled in the art. By way of example, the layers can be produced via extrusion, coextrusion, or the CAST process.

The outer layer (2) is applied here to the inner layer (3) via coextrusion, lamination, or adhesive bonding. The coextrusion method is preferred.

In one preferred embodiment of the process for the production of a multilayer molding (1), the outer layer (2) and inner layer (3) are produced simultaneously via coextrusion.

In one embodiment of the multilayer molding (1) of the invention, produced via coextrusion, the layer thickness of the outer layer (2) is from 0.01 mm to 0.15 mm. It is preferable that the layer thickness of the outer layer here is from 0.015 to 0.1 mm, very preferably from 0.02 to 0.09 mm, in particular from 0.025 to 0.08 mm.

In one embodiment of the multilayer molding (1), the melt viscosity of the thermoplastic polymer of the outer layer (2) corresponds to the melt viscosity of the thermoplastic polymer of the inner layer (3). In another embodiment of the multilayer molding (1), the melt viscosities of the thermoplastic polymers of the outer layer (2) and of the inner layer (3) can differ from one another by up to 10%, but the difference is preferably less than 5% and very preferably less than 1%.

It is generally advantageous during the production of the multilayer molding via, for example, lamination or coextrusion, to match the melt viscosities of the thermoplastic polymers of the outer layer (2) and of the inner layer (3) to one another.

In one preferred embodiment of the process for the production of a multilayer molding (1), the melt viscosities of the thermoplastic polymers of the outer layer (2) and of the inner layer (3) differ by up to 10% from one another, particularly at the site of first contact of the melts, and the difference is preferably less than 5% and very preferably less than 1%.

The multilayer moldings of the invention are generally produced via extrusion followed by lamination of the layers in a roll mill or in a “roll stack” process. The extrusion of the individual layers can by way of example be carried out in a single- or twin-screw extruder. It is preferable that the layers are extruded using a single-screw extruder and laminated in a roll mill. It is very preferable that the layers are coextruded in a single- or twin-screw extruder, particularly with a single-screw extruder, and optionally laminated in a roll mill. The roll mill here can by way of example have two or three rolls.

In one embodiment of the process of the invention, the IR absorbers are used in the form of a suspension. It is preferable that the suspension comprises a solids content of at least 10% by weight of nanoscale IR absorber, based on the total weight of the suspension, particularly preferably at least 20% by weight, and particularly at least 25% by weight. It is advantageous that the high solids content can give a high addition factor for the nanoscale IR absorber in the outer layer.

In one embodiment of the extrusion of the outer layer (2) and of the inner layer (3), the additives, for example the nanoscale IR absorber, are in particular added in the form of suspension, or a UV absorber is added to the extruder together with the thermoplastic polymer, at the inlet duct.

In another embodiment of the extrusion of the outer layer (2) and of the inner layer (3), the additives, for example the nanoscale IR absorber, particularly in the form of suspension, or a UV absorber, are added to the extruder in the form of a masterbatch. While the thermoplastic polymer is added to the extruder at the inlet duct, the masterbatch can be added to the extruder either also at the inlet duct or via a separate downstream inlet.

By way of example, in the production of the outer layer (2), the thermoplastic polymer is charged to the inlet duct of a single-screw extruder, while the nanoscale IR absorber in the form of a masterbatch is introduced to the extruder via a separate downstream inlet.

By way of example, in the production of the outer layer (2), the thermoplastic polymer is charged to the inlet duct of a single-screw extruder, while the nanoscale IR absorber and the UV absorber respectively in the form of a masterbatch are introduced into the extruder via a separate downstream inlet.

In another embodiment of the production process of the invention, the respective compositions for the outer layer (2) and the inner layer (3) are precompounded separately prior to the coextrusion process. These precompounded compositions can by way of example, prior to the coextrusion process, be first mixed in the melt in a single- or twin-screw extruder, or in a kneader or on a roll mill, and then processed to give any desired shapes, such as pellets or sheeting, which are then used for the coextrusion process. The precompounded compositions of the outer layer (2) and of the inner layer (3) are then introduced to their respective extruders for the coextrusion process.

In one preferred embodiment of the process of the invention, the outer layer (2) and the inner layer (3) are coextruded by passing the extrudates (melt streams) from the individual extruders into a feed-block die, where the extrudates are combined before they reach the die. In another embodiment, the extrudates enter the die separately and are not combined until they are within the final outlet.

Following the coextrusion process, coextruded multilayer moldings of the invention can then be rolled in a roll mill, and often take the form of a sheeting. The thickness of the resultant sheeting is generally from 0.5 to 35 mm.

The invention also provides the use of the multilayer moldings of the invention in heat management. Heat management comprises applications in automobiles, architecture, residential buildings and office buildings, warehouses, stadiums, airports, or other areas in which the heat generated by incident thermal radiation is undesired.

The multilayer moldings of the invention are mainly used in the construction sector, in vehicle construction, in air travel, in ship building, in railroad construction, and in the electrical or electronics industry, for example as filters for display screens.

The multilayer moldings of the invention are preferably used as glazing material or roof material, as agricultural sheeting, in particular greenhouse sheeting, or as a constituent of windows.

The multilayer moldings can, of course, also be used to produce articles, in particular components, which comprise a plurality of multilayer moldings. By way of example, a plurality of multilayer moldings can be present in the form of panels or sheeting separated by spacers, thus producing air channels between the panels or sheeting. The spacers can likewise be composed of the thermoplastic polymers of the outer layer (2) or of the inner layer (3). Components of this type can particularly be used for heat management in buildings.

It is, of course, also possible that the multilayer moldings are converted via additional process steps, such as thermoforming, or blow molding, into products of varying desired shape and geometry.

Use of the multilayer moldings of the invention, comprising nanoscale IR absorbers, permits effective shielding with respect to the action of thermal radiation on the surface of, for example, buildings, vehicles, or greenhouses. These materials permit heat management of interior spaces. These materials generally provide high transparency to visible light together with effective shielding from thermal radiation, and interior spaces therefore remain well lit when subject to insolation, with less temperature increase.

The examples and figures provide further explanation of the invention, but the examples or figures do not restrict the subject matter of the invention.

FIG. 1 shows a diagram of a multilayer molding (1) of the invention, with an outer layer (2) comprising nanoscale IR absorbers (8), and with inner layer (3), and with optional further layers (4), (5), (6) and (7). Thermal radiation (9) impacts the outer layer (2) of the multilayer molding (1).

1. A multilayer molding (1) comprising
a. an outer layer (2) comprising
i. a thermoplastic polymer and
ii. at least one nanoscale IR absorber (8), and also
b. an inner layer (3) arranged under the outer layer (2) and comprising
i. a thermoplastic polymer.

2. The multilayer molding (1) according to claim 1, where the outer layer (2) is in direct contact with the inner layer (3).

3. The multilayer molding (1) according to claim 1 or 2, where the thermoplastic polymer used in the outer layer comprises a polyacetal, polyacrylate, polyalkyl acrylate, polycarbonate, polystyrene, polyester, polyamide, polyamideimide, polyarylate, polyaryl sulfone, polyether sulfone, polyphenyl sulfide, polyvinyl chloride, polysulfone, polyimide, polyetherimide, polytetrafluoroethylene, polyetherketone, polyetheretherketone, polyetherketoketone, polybenzoxazole, polyoxadiazole, polybenzothiazinophenothiazine, polybenzothiazole, polypyrazinoquinoxaline, polypyromellitimide, polyquinoxaline, polybenzimidazole, polyoxindole, polyoxoisoindoline, polydisoxoisoindoline, polytriazine, polypyridazine, polypiperazine, polypyridine, polypiperidine, polytriazole, polypyrazole, polypyrrolidine, polycarborane, polyoxabicyclononane, polybicyclonone, polydibenzofuran, polyphthalide, polyacetal, polyanhydride, polyvinyl ether, polyvinyl thioether, polyvinyl alcohol, polyvinyl ketone, polyvinyl halide, polyvinyl nitrile, polyvinyl ester, polysulfonate, polysulfide, polythioester, polysulfonamide, polyurethane, polyphosphazine, polysilazane, polyimide, polymethyl methacrylate (PMMA), polyethylene terephthalate (PET), polyolefins, such as polyethylene (PE) or polypropylene (PP), acrylonitrile-styrene-acrylate (ASA), polyvinyl butyral, or a mixture composed of these.

4. The multilayer molding (1) according to claims 1 to 3, where the IR absorber is a nanoparticulate tin oxide doped with antimony or indium, or is a nanoparticulate boride of the rare earths.

5. The multilayer molding (1) according to claims 1 to 4, where the thermoplastic polymer used in the inner layer comprises polyacetal, polyacrylate, polyalkyl acrylate, polycarbonate, polystyrene, polyester, polyamide, polyamideimide, polyarylate, polyaryl sulfone, polyether sulfone, polyphenyl sulfide, polyvinyl chloride, polysulfone, polyimide, polyetherimide, polytetrafluoroethylene, polyetherketone, polyetheretherketone, polyetherketoketone, polybenzoxazole, polyoxadiazole, polybenzothiazinophenothiazine, polybenzothiazole, polypyrazinoquinoxaline, polypyromellitimide, polyquinoxaline, polybenzimidazole, polyoxindole, polyoxoisoindoline, polydisoxoisoindoline, polytriazine, polypyridazine, polypiperazine, polypyridine, polypiperidine, polytriazole, polypyrazole, polypyrrolidine, polycarborane, polyoxabicyclononane, polybicyclonone, polydibenzofuran, polyphthalide, polyacetal, polyanhydride, polyvinyl ether, polyvinyl thioether, polyvinyl alcohol, polyvinyl ketone, polyvinyl halide, polyvinyl nitrile, polyvinyl ester, polysulfonate, polysulfide, polythioester, polysulfonamide, polyurethane, polyphosphazine, polysilazane, polyimide, polymethyl methacrylate (PMMA), polyethylene terephthalate (PET), polyolefins, such as polyethylene (PE) or polypropylene (PP), acrylonitrile-styrene-acrylate (ASA), polyvinyl butyral, or a mixture composed of these.

6. The multilayer molding (1) according to claims 1 to 5, where the following are used as additional additives in the outer layer (2): UV absorbers, nonparticulate organic IR absorbers, stabilizers, antioxidants, colorants, inorganic salts, pearl-luster pigments, NIR-reflective substances, antifogging agents, or fillers.

7. The multilayer molding (1) according to claim 6, where a UV absorber is selected as additional additive in the outer layer (2).

8. The multilayer molding (1) according to claim 6, where a stabilizer is selected as additional additive in the outer layer (2).

9. The multilayer molding (1) according to claim 6, where stabilizers and UV absorbers are selected as additional additives in the outer layer (2).

10. The multilayer molding (1) according to claim 6, where stabilizers, UV absorbers, and antioxidants are selected as additional additives in the outer layer (2).

11. The multilayer molding (1) according to claims 1 to 10, where UV absorbers, nonparticulate organic IR absorbers, stabilizers, antioxidants, colorants, inorganic salts, pearl-luster pigments, NIR-reflective substances, antifogging agents, or fillers are used as additional additives in the inner layer (3).

12. The multilayer molding (1) according to claims 1 to 11, which takes the form of a panel or sheeting.

13. A process for the production of a multilayer molding (1), which comprises
a. applying an outer layer (2) comprising
i. a thermoplastic polymer,
ii. at least one nanoscale IR absorber,
iii. optionally at least one UV absorber,
iv. optionally at least one nonparticulate organic IR absorber, and
v. optionally antioxidants
b. to the surface of an inner layer (3) comprising
i. a thermoplastic polymer.

14. The process according to claim 13, wherein the outer layer (2) and the inner layer (3) are produced simultaneously or in succession.

15. A process for the production of a multilayer molding (1), which comprises
a. coextruding an outer layer (2) comprising
i. a thermoplastic polymer,
ii. at least one nanoscale IR absorber,
iii. optionally at least one UV absorber,
iv. optionally at least one nonparticulate organic IR absorber, and
v. optionally antioxidants
b. and an inner layer (3) comprising
i. a thermoplastic polymer.

16. The process according to claim 15, wherein the multilayer molding (1) is laminated.

17. The use of multilayer moldings according to claims 1 to 12 or of multilayer moldings produced according to claims 13 to 16, in heat management.

18. The use of multilayer moldings according to claims 1 to 12 or of multilayer moldings produced according to claims 13 to 16, as agricultural sheeting.

19. The use of multilayer moldings according to claims 1 to 12 or of multilayer moldings produced according to claims 13 to 16, as window component.

20. The use of multilayer moldings according to claims 1 to 12 or of multilayer moldings produced according to claims 13 to 16 as constituent of panels having cavities, twin-web panels, multi-web sandwich panels, or solid panels.

21. An article comprising multilayer moldings according to claims 1 to 12 or multilayer moldings produced according to claims 13 to 16.
